(19) United States
(12) Patent Application Publication
(10) Pub. No.: US 2014/0271444 A1
(43) Pub. Date: Sep. 18, 2014

(54) FRACTIONATION OF 2-DIMENSIONAL PLATE PARTICLES BY SIZE SELECTIVE ADHESION WITH SPHERICAL PARTICLES

(71) Applicant: KOREA INSTITUTE OF SCIENCE AND TECHNOLOGY, Seoul (KR)

(72) Inventors: Sang-Soo LEE, Seoul (KR); Sinwoo KIM, Seoul (KR); Jonghwi LEE, Seoul (KR)

(73) Assignee: KOREA INSTITUTE OF SCIENCE AND TECHNOLOGY, Seoul (KR)

(21) Appl. No.: 14/063,086

(22) Filed: Oct. 25, 2013

(30) Foreign Application Priority Data
Mar. 18, 2013 (KR) 10-2013-0028741

(51) Int. Cl. C01B 31/04

(52) U.S. Cl. CPC C01B 31/0484
USPC 423/448

(57) ABSTRACT

The present disclosure relates to a method for size-selective separation of 2-dimensional plate particles using spherical particles. Since the separation method of 2-dimensional plate particles according to the present disclosure is simple, economical and extensible to large-scale applications, it can contribute greatly to commercialization of plate particles by reducing cost and preventing deterioration of physical properties. The 2-dimensional plate particles having uniform size can be useful in such applications as transparent electrodes, solar cells, composites, drug delivery, biosensors, etc.

### CROSS-REFERENCE TO RELATED APPLICATIONS

This application claims priority under 35 U.S.C. §119 to Korean Patent Application No. 10-2013-0028741 filed on Mar. 18, 2013, in the Korean Intellectual Property Office, the disclosure of which is incorporated herein by reference in its entirety.

### TECHNICAL FIELD

The present disclosure relates to a method for size-selective separation of 2-dimensional plate particles using spherical particles.

### BACKGROUND

Graphene exhibits excellent properties including high charge mobility of 100 times that of silicon, high current density of 100 times that of copper, excellent thermal conductivity, low heat generation, good chemical resistance, high mechanical strength, applicability to various chemical reactions, flexibility, or the like. With these properties, graphene is expected to be applicable in various applications including touch screens, displays, solar cells, etc. To realize the high versatility of graphene, it is necessary to obtain graphene of uniform area and properties.

For large-scale production of graphene for commercial use, oxidation and chemical exfoliation of graphite powder is employed the most. In this case, the size of obtained graphene oxide varies depending on the initial state of graphite, oxidizing agent used, reaction time, dispersion medium, etc. and the size distribution is very broad, ranging from tens of nanometers to tens of micrometers. Since it is known that the physical properties of graphene vary greatly depending on its size, it is necessary to solve the problem of broad size distribution in order to achieve superior and uniform physical properties.

Recently, separation of graphene by size through ultracentrifugation using density gradient was reported based on the fact that the density changes with particle size (ACS Nano, 4, 3381, (2010)). It is reported that, by producing various density gradients, graphene oxide and graphene having a relatively uniform size distribution from tens of nanometers to hundreds of nanometers could be obtained. However, this method is not appropriate for large-scale or commercial applications since the amount that can be separated once using an ultracentrifuge is extremely limited and sucrose solutions of various concentrations have to be prepared to produce the density gradients.

Graphene oxide in the form of 2-dimensional plates has different surface area to edge ratios depending on the size of the plate particles and the edge portion is rich in carboxyl groups which play a critical role in dispersion stability in water. Size-selective separation of graphene oxide by adjusting the pH of a graphene oxide dispersion based on this fact was reported (J. Am. Chem. Soc. 133, 6338, (2011)). It is known that the graphene oxide obtained through chemical exfoliation as dispersed in water can remain stably dispersed in water since the carboxyl groups at the edge portion are oxidized by releasing protons and negatively charged. If pH is changed and protons are bound again to the carboxyl groups, they lose charge and lack dispersion stability. Large-area graphene oxide, which has a small surface area to edge ratio, loses dispersion stability and is precipitated at high pH, relatively to small-area graphene oxide. Accordingly, the precipitated large-area particles can be separated from the small-area particles remaining dispersed. However, it is difficult to precisely control the size of the separated particles and a post-treatment process such as neutralization is necessary to restore the intrinsic properties of graphene.

Therefore, there is a need of a method for size-selective separation which is precise, simple and extensible to large-scale production in order to industrially utilize the graphene produced by chemical exfoliation which has a very broad size distribution.

### SUMMARY

The present disclosure is directed to providing a method for size-selective separation of 2-dimensional plate particles, which is capable of solving the problem of the broad particle size distribution of 2-dimensional plate particles and is extensible to large-scale production via a simple and fast process.

In one general aspect, there is provided a method for size-selective separation of 2-dimensional plate particles, including:

(a) mixing a dispersion of positively charged 2-dimensional plate particles with a dispersion of negatively charged spherical particles and stirring to obtain a mixture solution including unbound 2-dimensional plate particles and aggregates wherein the 2-dimensional plate particles are bound to the spherical particles; and

(b) separating the unbound 2-dimensional plate particles from a supernatant obtained by precipitating the aggregates in the mixture solution including the unbound 2-dimensional plate particles and the aggregate.

Since the separation method of 2-dimensional plate particles according to the present disclosure is simple, economical and extensible to large-scale applications, it can contribute greatly to commercialization of plate particles by reducing cost and preventing deterioration of physical properties. The 2-dimensional plate particles having uniform size can be useful in such applications as transparent electrodes, solar cells, composites, drug delivery, biosensors, etc.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 shows a dynamic light scattering (DLS) analysis result before and after size-selective separation of graphene oxide; and

FIG. 2 shows atomic force microscopic (AFM) images of graphene oxide particles before and after size-selective separation of graphene oxide.

### DETAILED DESCRIPTION OF EMBODIMENTS

Hereinafter, exemplary embodiments will be described in detail with reference to the accompanying drawings.

The present disclosure provides a method for size-selective separation of 2-dimensional plate particles, including:

(a) mixing a dispersion of positively charged 2-dimensional plate particles with a dispersion of negatively charged spherical particles and stirring to obtain a mixture solution including unbound 2-dimensional plate particles and aggregates wherein the 2-dimensional plate particles are bound to the spherical particles; and

(b) separating the unbound 2-dimensional plate particles from a supernatant obtained by precipitating the aggregates in the mixture solution including the unbound 2-dimensional plate particles and the aggregate.

In the method for size-selective separation of 2-dimensional plate particles according to the present disclosure, in (a), a dispersion of 2-dimensional plate particles and a dispersion of spherical particles, which have opposite surface charges, are mixed to obtain a mixture solution including unbound 2-dimensional plate particles and aggregates wherein the 2-dimensional plate particles are bound to the spherical particles.

Ionic bonding is formed between the plate particles and the spherical particles having opposite surface charge. Due to the attraction between the surfaces of the plate particles and the spherical particles, the plate particles are bent along the surface of the spherical particles and complex particles wherein the plate particles surround the spherical particles are formed.

If the length of the plate particles is smaller than the diameter of the spherical particles, the aggregates wherein the plate particles surround the spherical particles can be formed easily since the energy required for the bending of the plate particles is not large. But, if the length of the plate particles is 1.5 times the diameter of the spherical particles or greater, the binding energy of the ionic bonding is smaller than the energy required for the bending of the plate particles and no bonding is formed between the plate particles and the spherical particles.

Since only the plate particles of a specific size or smaller can be bound to the spherical particles, the plate particles which are significantly larger and cannot be bound to the spherical particles remain dispersed in the solution and can be separated from the bound plate particles.

The 2-dimensional plate particles in (a) may be selected from a group consisting of graphene, graphene oxide and graphite nanosheet. Specifically, graphene may be used.

The spherical particles in (a) may be polymer particles or inorganic spherical particles.

The polymer particle may be a polymer including a monomer and a comonomer and a commercially available one may be used. Specifically, the polymer particles may be prepared considering the size of the 2-dimensional plate particles.

The monomer used for preparing the polymer particles of (a) may be an aromatic vinyl compound selected from a group consisting of styrene, α-methylstyrene, α-chlorostyrene, p-tert-butylstyrene, p-methylstyrene, p-chlorostyrene, o-chlorostyrene, 2,5-dichlorostyrene, 3,4-dichlorostyrene, dimethylstyrene and divinylbenzene or an unsaturated carboxylic acid selected from a group consisting of methyl acrylate, methyl methacrylate, ethyl acrylate, ethyl methacrylate, propyl acrylate, propyl methacrylate, butyl acrylate and butyl methacrylate.

Specifically, it may be styrene, methyl methacrylate or α-methylstyrene.

The comonomer used for preparing the polymer particles of (a) may be any organic or inorganic material capable of providing positive charge to the polymer particles. In particular, when a basic polymer is used, the comonomer may be selected from a group consisting of polyethyleneimine, polyethylene glycol methyl methacrylate, polyethylene glycol methyl ether methacrylate, polyethylene glycol methacrylate, polypropylene glycol methacrylate, polypropylene glycol dimethacrylate, cetrimonium bromide and methacryloxyethyltrimethylammonium chloride.

Specifically, it may be polyethyleneimine, methacryloxyethyltrimethylammonium chloride or cetrimonium bromide.

As a crosslinking agent used to prepare the polymer particles, a styrene-based, acrylic or methacrylic lipophilic monomer having two or more vinyl groups as crosslinking functional groups per unit may be used in an amount of 1-2 wt % based on the monomer.

The crosslinking agent serves to bind the monomer with the comonomer to prepare the polymer particles. If it is used in an amount outside the above-described range, yield of the polymer particles may decrease and size of the particles may be non-uniform.

As a polymerization initiator used to prepare the polymer particles, a persulfate-based initiator such as potassium persulfate (K₂S₂O₈), ammonium persulfate ((NH₃)₂S₂O₈), sodium persulfate (Na₂S₂O₈), etc., a peroxide-based initiator such as hydrogen peroxide (H₂O₂), benzoyl peroxide, lauryl peroxide, etc. or an azo-based initiator such as azobisisobutyronitrile (AIBN), azobisformamide, etc. may be used in an amount of specifically 0.1-2 wt % based on the total weight.

The polymerization initiator imitates polymerization of the monomer with the comonomer. If it is used in an amount outside the above-described range, size control of the polymer particles is difficult, control of reaction time is difficult and long time is required for purification.

The inorganic spherical particles may be selected from a group consisting of silica (SiO₂), titania (TiO₂), zirconia (ZrO), magnesia (MgO) and alumina (Al₂O₃) particles.

A solvent used as a dispersion medium of the dispersions in (a) may be selected from a group consisting of water, dimethyl sulfoxide (DMSO), tetrahydrofuran (THF), dimethylformamide (DMF), benzene, xylene, toluene, cyclohexane, methanol, ethanol, propanol, isopropanol, butanol, isobutanol, t-butanol and a mixture thereof.

Specifically water, dimethylformamide, tetrahydrofuran or dimethyl sulfoxide may be used.

The solvent may be adequately changed by those skilled in the art depending on the spherical particles used. Specifically, a solvent in which the plate particles can be dispersed well may be used. In particular, for spherical polystyrene particles, water may be used as the solvent since the spherical particles are not soluble but the plate particles can be dispersed well.

The dispersion of spherical particles in (a) may have a concentration of 0.00001-50 wt %, specifically 0.00001-10 wt %, more specifically 0.00001-1 wt %.

This concentration generally allows maintenance of stable dispersion. Outside the above-described range, particularly, if the concentration of the dispersion is below 0.00001 wt %, size-selective separation of the plate particles may be difficult due to insufficient bonding with the plate particles. And, if the concentration of the dispersion exceeds 50 wt %, stable dispersion cannot be maintained.

The dispersion of plate particles in (a) may have a concentration of 0.00001-20 wt %, specifically 0.00001-1 wt %.

This concentration generally allows maintenance of stable dispersion. Outside the above-described range, particularly, if the concentration of the dispersion is below the above-described range, the absolute amount of particles obtained after purification may decrease. And, if the concentration of the dispersion is above the above-described range, stable dispersion cannot be maintained and physical properties may deteriorate due to aggregation of the plate particles.

In (a), the plate particles and the spherical particles are mixed at a volume ratio of 1:0.1-5, specifically 1:1-1.5.

Outside the above-described range, precipitation may not occur and thus separation may be difficult. Particularly, if the plate particles are mixed with an excess amount, the desired large-area plate particles cannot be obtained uniformly because of unbound small particles.

Since the precipitation of the aggregates in (b) may be achieved by spontaneous precipitation without physical or chemical treatment, cost reduction and prevention of physical property deterioration may be achieved.

Since the separation method of 2-dimensional plate particles according to the present disclosure is simple, economical and extensible to large-scale applications, it can contribute greatly to commercialization of plate particles by reducing cost and preventing deterioration of physical properties. The 2-dimensional plate particles having uniform size can be useful in such applications as transparent electrodes, solar cells, composites, drug delivery, biosensors, etc.

### EXAMPLES

Hereinafter, the present disclosure will be described in more detail through examples and test examples.

However, the following examples and test examples are for illustrative purposes only and not intended to limit the scope of this disclosure.

Materials

Polymer particles were used as spherical particles. Although commercially available polymer particles may be used, uniform polymer particles having a size of hundreds of nanometers were prepared through single-step emulsion polymerization in order to obtain particles of size desired by the present disclosure. The polymer particles may include the monomer and the comonomer described above. In the following examples, polymer particles including styrene were used.

### Preparation Example 1

### Preparation of Polystyrene Dispersion

A dispersion of spherical particles was prepared as follows. 20 g of styrene was added to 200 mL of water. After carrying out emulsion polymerization by adding 0.1 g of potassium persulfate as a polymerization initiator, the product was diluted to obtain a 1 wt % polystyrene aqueous dispersion. To positively charge polystyrene particles, the dispersion was mixed with a 1% aqueous solution of polyethyleneimine (PEI) which is a basic polymer. After stirring for 24 hours at 300 rpm, followed by centrifugation, only the polystyrene particles were recovered and redispersed in deionized water to obtain a 0.167% polystyrene aqueous dispersion.

Measurement of Surface Charge

The surface charge of the polystyrene particles was measured. The polystyrene particles exhibited a zeta potential of +35 mV and had a positive surface charge.

### Preparation Example 2

### Preparation of Graphene Dispersion

Graphene was used as plate particles. Dispersed graphene oxide, which was obtained from graphite through chemical oxidation followed by ultrasonication, was reduced with hydrazine to obtain graphene. The product was diluted with deionized water to obtain a 0.02 wt % graphene oxide aqueous dispersion.

Measurement of Surface Charge

The surface charge of the graphene particles was measured. The graphene particles exhibited a zeta potential of −29 mV and had a negative surface charge.

### Example 1

### Step 1

### Preparation of Mixture of Graphene Dispersion and Polystyrene Dispersion

The dispersion of positively charged polystyrene particles obtained in Preparation Example 1 and the dispersion of negatively charged graphene particles obtained in Preparation Example 2 were mixed at 1:2 and stirred.

As a result, graphene-polystyrene aggregate wherein graphene is bound to the surface of polystyrene by ionic bonding were formed.

### Step 2

### Separation of Unbound 2-Dimensional Plate Particles From Supernatant

The aggregates obtained in the step 1, whose dispersion stability in aqueous solution is decreased owing to the decreased free surface charge as a result of the ionic bonding, were precipitated at room temperature for 24 hours. Then, large-sized graphene not bound to the polystyrene particles was obtained from the supernatant.

### Comparative Example 1

An experiment was carried out in the same manner as in Example 1, except for using only the graphene dispersion instead of mixing the graphene dispersion with the polystyrene dispersion.

### Test Example 1

### Observation of Particle Size Distribution

The particle size distribution of the graphenes separated in Example 1 and Comparative Example 1 was observed by dynamic light scattering (DLS). The result is shown in FIG. 1.

Result

As seen from FIG. 1, the average particle size of graphene increased from 290 nm to about 750 nm after the separation. This suggests that, since the spherical particles according to the present disclosure, i.e. the polystyrene particles, have a size of hundreds of nanometers, it is difficult for the graphene particles larger in size to surround and be bound to the spherical particles. Accordingly, it can be seen that graphene particles larger in size than the spherical particles can be separated by the method according to the present disclosure.

### Test Example 2

### Observation of Particle Size

The particle size of the graphenes separated in Example 1 and Comparative Example 1 was observed by atomic force microscopy (AFM). The result is shown in FIG. 2.

Result

FIG. 2 shows atomic force microscopic (AFM) images of graphene oxide particles before and after size-selective separation of graphene oxide. FIG. 2 (a) shows an AFM image of the graphene particles of Comparative Example 1 before separation and FIG. 2 (b) shows an AFM image of the graphene particles separated in Example 1. As seen from FIG. 2, small particles of about 300 nm or smaller in size are remarkably decreased after the separation. The AFM analysis result reveals that the dispersion state is maintained after the separation.

Since the separation method of 2-dimensional plate particles according to the present disclosure is simple, economical and extensible to large-scale applications, it can contribute greatly to commercialization of plate particles by reducing cost and preventing deterioration of physical properties. The 2-dimensional plate particles having uniform size can be useful in such applications as transparent electrodes, solar cells, composites, drug delivery, biosensors, etc

While the present disclosure has been described with respect to the specific embodiments, it will be apparent to those skilled in the art that various changes and modifications may be made without departing from the spirit and scope of the disclosure as defined in the following claims.

What is claimed is:

1. A method for size-selective separation of 2-dimensional plate particles, comprising:
(a) mixing a dispersion of positively charged 2-dimensional plate particles with a dispersion of negatively charged spherical particles and stirring to obtain a mixture solution comprising unbound 2-dimensional plate particles and aggregates wherein the 2-dimensional plate particles are bound to the spherical particles; and
(b) separating the unbound 2-dimensional plate particles from a supernatant obtained by precipitating the aggregates in the mixture solution comprising the unbound 2-dimensional plate particles and the aggregate.

2. The method according to claim 1, wherein the aggregates in (a) are complex particles wherein the plate particles surround the spherical particles.

3. The method according to claim 1, wherein the 2-dimensional plate particles in (a) are selected from a group consisting of graphene, graphene oxide and graphite nanosheet.

4. The method according to claim 1, wherein the spherical particles in (a) are polymer particles or inorganic spherical particles.

5. The method according to claim 4, wherein the polymer particle is a copolymer comprising a monomer and a comonomer.

6. The method according to claim 5, wherein the monomer is an aromatic vinyl compound selected from a group consisting of styrene, α-methylstyrene, α-chlorostyrene, p-tert-butylstyrene, p-methylstyrene, p-chlorostyrene, o-chlorostyrene, 2,5-dichlorostyrene, 3,4-dichlorostyrene, dimethylstyrene and divinylbenzene or an unsaturated carboxylic acid selected from a group consisting of methyl acrylate, methyl methacrylate, ethyl acrylate, ethyl methacrylate, propyl acrylate, propyl methacrylate, butyl acrylate and butyl methacrylate.

7. The method according to claim 5, wherein the comonomer is selected from a group consisting of polyethylene glycol methyl methacrylate, polyethylene glycol methyl ether methacrylate, polyethylene glycol methacrylate, polypropylene glycol methacrylate, polypropylene glycol dimethacrylate and methacryloxyethyltrimethylammonium chloride.

8. The method according to claim 4, wherein the inorganic spherical particles are selected from a group consisting of silica (SiO₂), titania (TiO₂), zirconia (ZrO), magnesia (MgO) and alumina (Al₂O₃) particles.

9. The method according to claim 1, wherein a solvent used as a dispersion medium of the dispersions in (a) is selected from a group consisting of water, dimethyl sulfoxide (DMSO), tetrahydrofuran (THF), dimethylformamide (DMF), benzene, xylene, toluene, cyclohexane, methanol, ethanol, propanol, isopropanol, butanol, isobutanol, t-butanol and a mixture thereof.

10. The method according to claim 1, wherein the aggregates wherein the 2-dimensional plate particles are bound to the spherical particles of (a) are formed by ionic bonding between the plate particles and the spherical particles.

11. The method according to claim 1, wherein the dispersion of spherical particles in (a) has a concentration of 0.00001-50 wt %.

12. The method according to claim 1, wherein the dispersion of plate particles in (a) has a concentration of 0.00001-20 wt %.

13. The method according to claim 1, wherein, in (a), the plate particles and the spherical particles are mixed at a volume ratio of 1:0.1-5.

14. The method according to claim 1, wherein the precipitation of the aggregates in (b) is achieved by spontaneous precipitation without physical or chemical treatment.
